(19) United States
(12) Patent Application Publication
(10) Pub. No.: US 2025/0020098 A1
(43) Pub. Date: Jan. 16, 2025

(54) AN APPARATUS FOR GENERATING ELECTRICITY FROM WATER FLOW

(71) Applicant: VERDERG RENEWABLE ENERGY LIMITED, Woking Surrey (GB)

(72) Inventors: Peter Roberts, Woking Surrey (GB); Robert Kettle, Woking Surrey (GB)

(21) Appl. No.: 18/710,494

(22) PCT Filed: Nov. 15, 2022
(86) PCT No.: PCT/GB2022/052891

§ 371 Date: May 15, 2024

(30) Foreign Application Priority Data
Nov. 15, 2021 (GB) 2116451.2

(51) Int. Cl. F03B 17/06

(52) U.S. Cl. CPC F03B 17/061; F05B 2210/11; F05B 2220/32; F05B 2230/60; F05B 2240/133

(57) ABSTRACT

An apparatus for generating electricity from water flow comprising: a convergent section connected at a downstream end thereof to an upstream end of a mixing chamber such that a venturi is formed; a diffuser section connected to a downstream end of the mixing chamber, the diffuser configured such that in use the static pressure at the exit of the diffuser is greater than the static pressure at the venturi; at least part of a tube located in the convergent section, such that an annulus is defined between the tube and the convergent section, to form a first flow passage, and the tube defining a second flow passage within the tube; and a turbine, which is connected with the tube and connectable to a generator, wherein the turbine is located within a turbine chamber that is connected at a downstream end thereof to an upstream end of the convergent section.

The present disclosure relates to an apparatus for generating electricity from water flow.

Many systems have been proposed for converting water flows into electricity. These systems require dams, weirs, or other artificial structures to block the flow of water across a body of water creating a head of water. With sufficient available head, water is released to flow through turbines to generate electrical power thus converting the potential energy stored in the water into useful power. One type of device that is used in power generating systems is the Kaplan turbine.

There are numerous shortcomings with the prior art systems, some of which are considered below.

In practice, prior art systems require a high flow rate and operate at relatively low speeds to enable their use for commercial energy production. Operating at such high flow rates requires the systems to have large diameters.

Prior art systems typically require a deep excavated turbine house in/adjacent to the upstream water source to allow the apparatus to be fully submerged. Deeper upstream water levels reduce the risk of cavitation and acts to prevent the formation of free surface vortices being drawn into the turbine. To prevent cavitation, the turbine blades must rotate slowly and therefore require a gearbox to step up the shaft speed for the generator.

Prior art systems typically require large screens upstream of the turbine intake to prevent the entrainment of fish and other aquatic life through the turbines.

The present invention arose in a bid to provide an improved apparatus for generating electricity from water flow, in particular, to such an apparatus allowing for lower cost, simplified installation. The apparatus is preferably self-contained.

According to the present invention in a first aspect, there is provided an apparatus for generating electricity from water flow comprising: a convergent section connected at a downstream end thereof to an upstream end of a mixing chamber such that a venturi is formed; a diffuser section connected to a downstream end of the mixing chamber, the diffuser configured such that in use the static pressure at the exit of the diffuser is greater than the static pressure at the venturi; at least part of a tube located in the convergent section, such that an annulus is defined between the tube and the convergent section, to form a first flow passage, and the tube defining a second flow passage within the tube; and a turbine, which is connected with the tube and connectable to a generator, wherein the turbine is located within a turbine chamber that is connected at a downstream end thereof to an upstream end of the convergent section.

By the connection of the turbine with the tube, which may otherwise be referred to as a turbine tube or turbine draft tube, the arrangement is such that the turbine is driven by the pressurised flow of fluid through the tube, most preferably the turbine is driven solely by pressurised fluid flow through the tube.

The turbine chamber is preferably connected at an upstream end thereof to an inlet pipe. The inlet pipe preferably has a substantially constant cross sectional area. The turbine chamber may be connected directly to the inlet pipe or it may, more preferably, be connected to the inlet pipe via/through a second (or inlet) diffuser. In such case, the second diffuser will be connected to the turbine chamber at a downstream end thereof and to the inlet tube at an upstream end thereof. When present, the second diffuser will reduce the velocity of the water as it enters the turbine chamber.

The turbine chamber defines a closed volume. It is closed except for the inlet and outlet. The turbine chamber is preferably pressurised in use. It is preferably fully filled with water so that there is no free surface.

The turbine chamber preferably defines a self-contained turbine module for connection to the upstream and downstream components of the apparatus.

The turbine chamber preferably has a constant cross sectional area. It may comprise a substantially cylindrical inner surface.

The turbine chamber is preferably arranged to be opened so as to allow access for installation and maintenance works. There may be provided a hatch for such purposes.

The turbine chamber may be mounted such that it is outside of the water, or is fully or partially submerged.

The turbine and/or the tube are preferably slidably mounted within the turbine chamber. They may be mounted to a skid that is housed within the turbine chamber.

The inlet pipe preferably has a fully submerged inlet.

The inlet pipe preferably comprises a debris screen at its upstream end.

The inlet pipe may be a siphon tube wherein the inlet pipe is inverted so as to rise to a level above an upstream water level. The inlet pipe in such case may be primed with a vacuum pump. Where the inlet pipe takes the form of a siphon tube, the flow of water through the apparatus may be controlled by managing the air pressure in the inlet pipe. In such case flow through the apparatus may be shut off by permitting air into the inlet pipe so as to break the siphon.

The mixing chamber preferably has a length that is at least double its inner diameter.

According to the present invention in a further aspect, there is provided an apparatus for generating electricity from water flow comprising: a convergent section connected to an upstream end of a mixing chamber such that a venturi is formed; a diffuser section connected to a downstream end of the mixing chamber, the diffuser configured such that in use the pressure at the exit of the diffuser is greater than the pressure at the venturi; at least part of a tube located in the convergent section, such that an annulus is defined between the tube and the convergent section, to form a first flow passage, and the tube defining a second flow passage within the tube, and a turbine, which is connected with the tube and connectable to a generator, wherein the mixing chamber has a length that is at least double its diameter.

In accordance with the second aspect, the turbine chamber, inlet tube and inlet diffuser may be omitted. These elements may otherwise be included in line with the first aspect.

Further features which may be adopted in respect of either the first or second aspects are now briefly discussed:

The turbine chamber may have a constant cross sectional area. It may comprise a substantially cylindrical inner surface. The inner surface may otherwise taper at an angle of up to 4 degrees along all or a part of its length.

There may be provided a tailpipe, which is connected to an outlet of the diffuser. The tailpipe may be used to connect to a downstream body of water. The downstream end of the tailpipe is preferably fully submerged in the water.

The convergent section, mixing chamber and diffuser section may together be considered to define a pressure amplification section. The tailpipe, when present, may be considered to form part of the pressure amplification system. The pressure amplification section reduces the pressure at the outlet of the turbine amplifying the available pressure across it. The diffuser section, which is connected to the end of the mixing chamber, is where the pressure will be recovered.

The tube preferably comprises a screen at its upstream end, in front of the turbine. The screen may be substantially conical in form. The size of the apertures in the screen will be selected to allow a suitable flow of water through the tube, whilst preventing fish and other marine animals (otters, etc.) from entering the turbine. The screen may be made from any suitable material. It may comprise a perforated metal screen.

Since there is no turbine in the pressure amplification section, the passage of fish and other marine animals downstream is not impeded. They can swim safely from the upstream side to the downstream side. The apparatus is able to recover a large amount of energy from the water flow whilst not damaging the fish and other animals.

The inlet of the tube is preferably connected to the turbine. When the turbine chamber is provided, it is preferable that the inlet is in the turbine chamber. The outlet is preferably located in the venturi region. The tube and the elements of the pressure amplification section are preferably coaxial.

The tube can be preferably be axially moved forward or backward relative to the convergent section and the mixing chamber in order to maximize performance. This may be achieved by slidably mounting the tube. The downstream end of the tube may be positioned level with the venturi section, upstream of the venturi section, or downstream of the venturi section. The end of the tube can be selectively moveable between/fixable in these positions.

The tube may be supported within a hub, connected to the turbine. The hub may have a smooth profile to minimize flow interference. The tube may be connected to the turbine and cantilevered into the venture during installation of the tube.

Any or all of the tube, hub and turbine may be supported by a skid, which may be attached to a lower part of the turbine chamber when present.

Irrespective of its mounting the outlet of the tube is preferably positioned in order to optimise the secondary flow rate through the tube and the pressure difference between the upstream and downstream ends of the tube.

The ratio of the cross-sectional area of the entrance of the mixing chamber and the cross-sectional area of the tube is preferably selected to optimise the secondary flow rate through the tube and the pressure difference between the upstream end and downstream ends of the tube.

The diameter of the turbine may determine the diameter of the tube. The tube may have a substantially uniform diameter along its length, with the inlet and exit having substantially the same diameter.

In order to maintain the right ratio between the cross cross-sectional area of the entrance of the mixing chamber and the cross sectional area of the end of the secondary tube, the diameter along the secondary tube may vary. If the turbine diameter is smaller than the optimal outlet diameter of the tube, the profile of the tube may be slightly divergent. Otherwise, it may be slightly convergent.

The ratio of the cross-sectional area of the entrance of the convergent section to the cross-sectional area of the entrance of the mixing chamber is preferably selected to optimise the secondary flow rate through the tube and the pressure difference between the upstream and downstream ends of the tube.

The ratio of the cross-sectional area of the entrance of the convergent section to the cross-sectional area of the exit of the diffuser section is preferably selected to optimise the performance of the device.

The turbine may be connected coaxially to a generator by a drive shaft. Alternatively, the turbine may be connected to a remote generator. The connection to the generator may be by a pulley wheel, a drive belt, a chain, one or more gear wheels or drive shafts, or any mixture of the above. A pipe enclosing those components may be connected in the turbine shaft.

The exit of the diffuser section and/or the entrance of the convergent section may have a substantially rectangular, circular or oval cross section.

The mixing chamber may have a substantially circular cross section along its length.

A flow control apparatus may be provided for controlling fluid flow through the apparatus. The flow control apparatus may, for example, comprise a sluice gate or a valve. The flow control apparatus may be located upstream of the tube, downstream of the outflow pipe or at any point in between.

The apparatus can be used to provide a flow passage through a barrier. A barrier may be a naturally occurring structure or a dam or other such structure in a body of water that creates a high pressure reservoir or containment of water on one side.

A further aspect of the invention comprises a system for generating electricity from water flow comprising; a barrier for locating across the cross-section of a flowing body of water; and provided with at least one apparatus as described above, wherein the apparatus is positioned such that in use it provides a flow path from the upstream side of the barrier to the downstream side of the barrier.

A further aspect of the invention comprises a method for providing a flow passage through a barrier across a body of water comprising: installing an apparatus as described above in the barrier.

A further aspect of the invention comprises a method of generating electricity from a flow of water comprising: installing a system or apparatus as described above across a body of water to provide a reservoir of water, such that a head difference is created between the downstream and upstream sides of the barrier; and using the flow of water through the apparatus to rotate the turbine.

In the present application, the terms “upstream” and “downstream” are used to define relative locations of features of the apparatus. The upstream and downstream directions are defined in relation to the direction which the water flows through the apparatus in use. The upstream end can be considered the input region and the downstream end can be considered the output region.

In the present application where two elements are specified to be connected to one another they may be connected to one another with a fluid tight seal. They may otherwise be co-formed.

These and other aspects and features of the present disclosure will be more readily understood when read in conjunction with the accompanying drawings. Moreover, it must be noted that the various features of any of the above statements may be combined without restriction, as will be readily appreciated by those skilled in the art.

Non-limiting embodiments of the invention will now be described by way of example with reference to the accompanying drawings, in which:

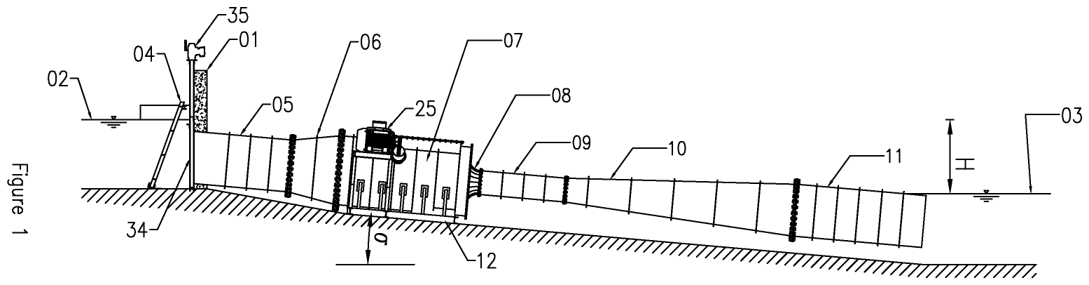

FIG. 1 shows a side view of an apparatus according to an embodiment of the invention comprising a ducted inlet pipe and an upstream sluice gate. The invention is shown inclined from the intake to the discharge;

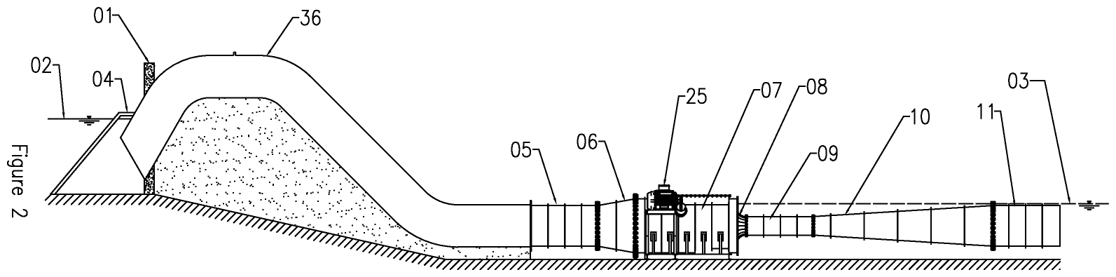

FIG. 2 shows a side view of the apparatus of FIG. 1, further comprising a siphoned inlet;

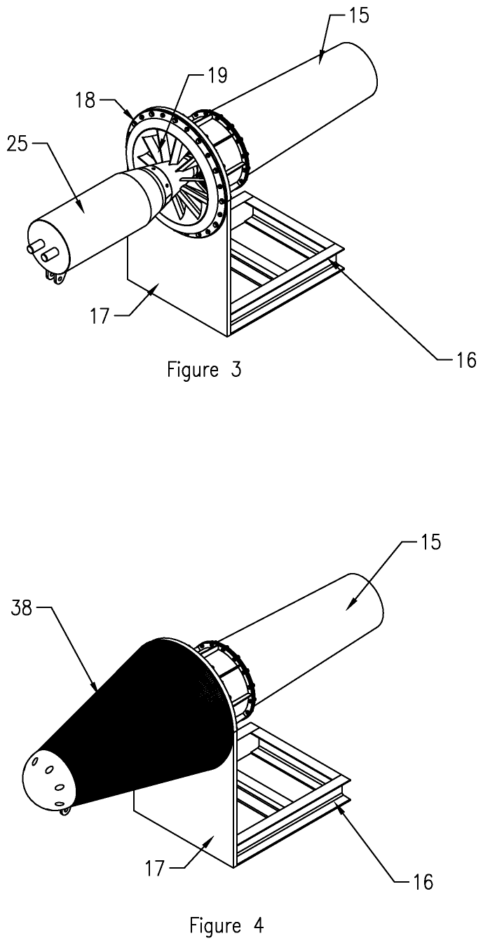

FIG. 3 shows a turbine arrangement comprising a support skid with submerged generator;

FIG. 4 shows the turbine arrangement of FIG. 3 with an upstream fish screen included;

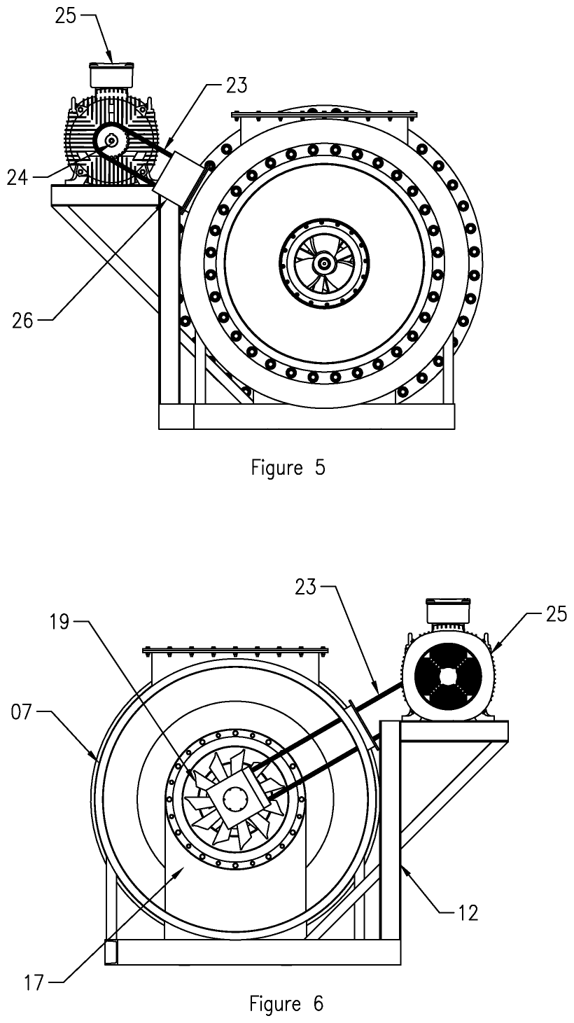

FIG. 5 shows a view looking upstream through the turbine chamber according to the arrangement of FIG. 1 or 2 and showing the generator mounted to the turbine chamber skid;

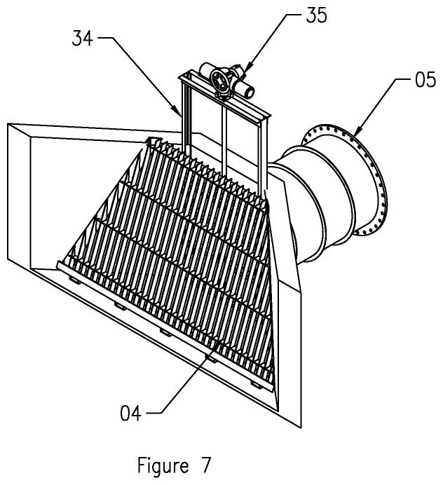

FIG. 6 shows a view looking downstream through the turbine chamber according to the arrangement of FIG. 1 or 2, wherein the cover sealing pipe is removed to show a view of a drive chain for the generator;

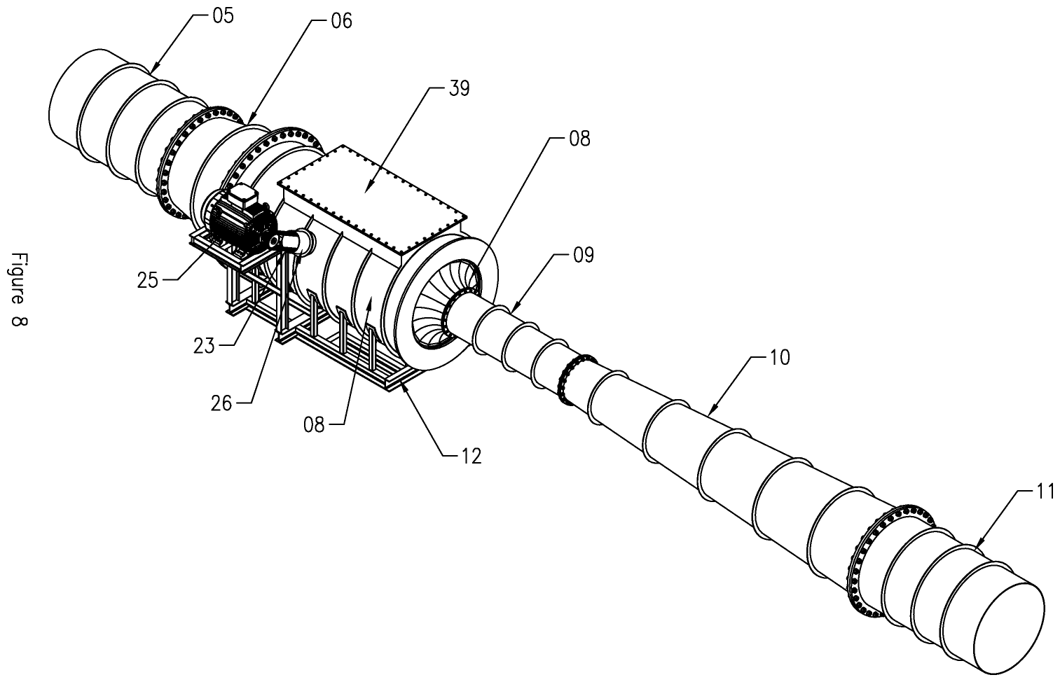

FIG. 7 shows a perspective view of the upstream debris screen mounted upstream of the inlet, wherein a sluice gate for controlling flow through the inlet pipe is shown;

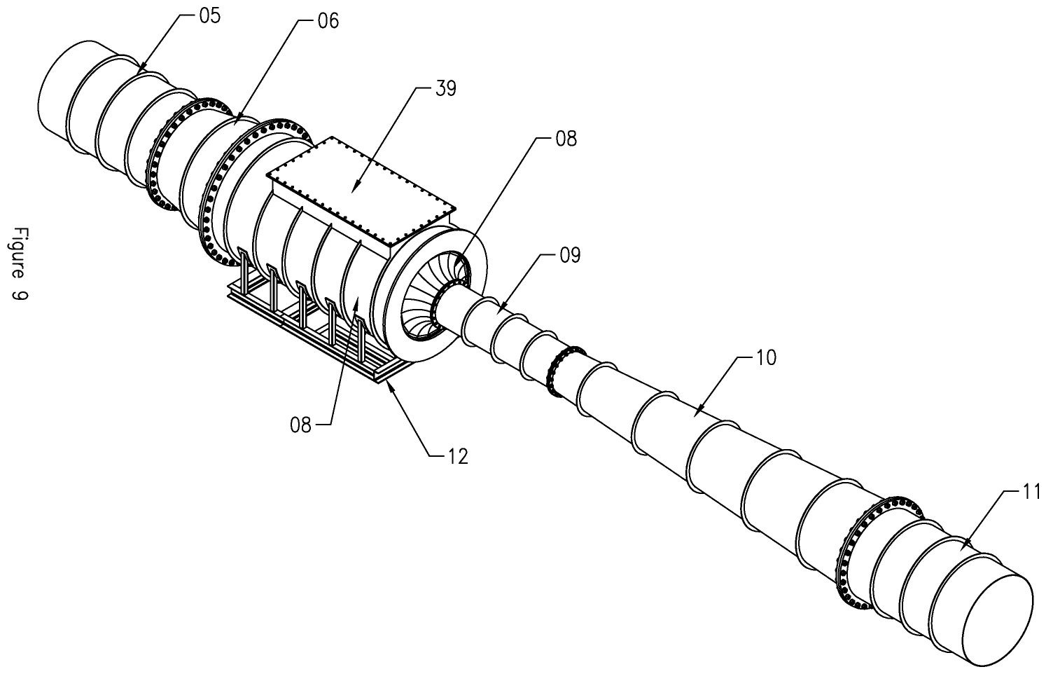

FIG. 8 is an isometric view of the apparatus of FIG. 1;

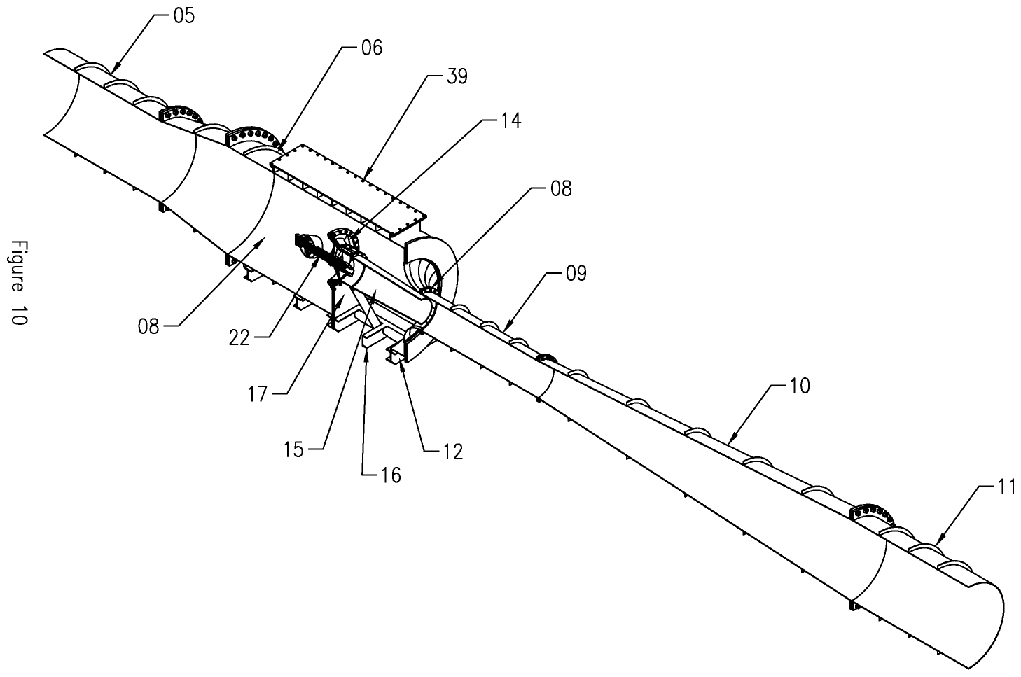

FIG. 9 is an isometric view corresponding to FIG. 8 but with the external generator replaced with an internal, submerged, generator;

FIG. 10 is a sectional view of the arrangement of FIG. 9 with the screen (as seen in FIG. 4) omitted;

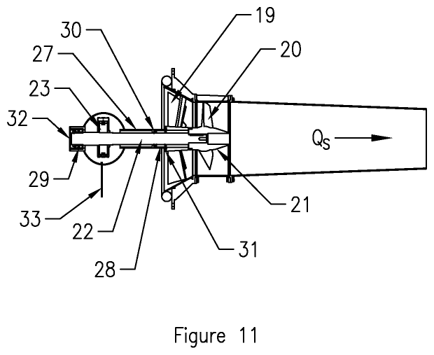

FIG. 11 is a section cut through the turbine assembly according to that used in FIGS. 1 and 8 comprising sprockets/pulleys fitted on the drive shaft to link to an external generator, wherein the tube is shown to taper down in the downstream direction.

With reference to the figures, there is shown an apparatus for generating electricity from water flow comprising: a convergent section 8 connected at a downstream end thereof to an upstream end of a mixing chamber 9 such that a venturi is formed; a diffuser section 10 connected to a downstream end of the mixing chamber 9, the diffuser section 10 configured such that in use the pressure at the exit of the diffuser section 10 is greater than the pressure at the venturi; at least part of a tube 15 located in the convergent section 8, such that an annulus is defined between the tube 15 and the convergent section 8, to form a first flow passage, and the tube 15 defining a second flow passage within the tube; and a turbine 14, which is connected with the tube 15 and connectable to a generator 25.

The turbine 14, as is the case in the depicted arrangements, is preferably located within a turbine chamber (or duct) 7 that is connected at downstream end thereof to an upstream end of the convergent section 8. Additionally, or alternatively, the mixing chamber 9 preferably has a length that is at least double its diameter.

A detailed consideration of the depicted, non-limiting, arrangements will now be provided.

FIG. 1 and FIG. 2 show system for converting water flow into electricity. The system converts hydraulic potential energy into mechanical energy and then into electrical energy. The system comprises a barrier 1 positioned across the width of a body of water and an apparatus, as broadly defined above, providing a flow passage for water through the barrier from the upstream side of the barrier to the downstream side of the barrier.

The apparatus provides a flow passage from an upstream water level 2 to a water level 3 downstream of the barrier 1. The apparatus comprises an inlet pipe 5 drawing flow from the upstream body of water. The inlet pipe preferably feeds into a diffuser 6 (the claimed second diffuser) which reduces the flow velocity before it enters the turbine chamber (or duct) 7. The diffuser 6 may, however, be omitted. Flow from the turbine chamber 7 enters the convergent section 8, which narrows down and increases the flow velocity, before it enters the mixing chamber 9. After the mixing chamber 9 the flow passes through the divergent section 10 and then the discharge tailpipe 11. The narrowing of the convergent section 8 towards the mixing chamber 9 creates a venturi 13.

The apparatus can be installed at in inclined angle, θ, as seen in FIG. 1, to reduce civil works and installation times, whilst the inlet and tailpipe remain submerged below the water line.

The barrier across the body of water 1 provides a pressure head immediately upstream of the apparatus. This converts some of the kinetic energy from the flow further upstream into potential energy of the raised water level as the flow slows down as the water depth behind the barrier increases. The resulting head difference H, as shown in FIG. 1, permits the conversion of the potential energy into useful mechanical energy. Water from the upstream side of the barrier flows through the inlet tube, through the turbine duct, continuing into the convergent section and mixing section, and then out of the apparatus via the diffuser section. A secondary flow through the turbine draft tube is induced which drives the rotation of the turbine tube via the blade assembly generating electricity via a mechanical or electrical power offtake arrangement.

The turbine 14 is housed by and supported within the turbine chamber 7. The tube 15 extends into the convergent section 8 such that an annulus is formed between the outer surface of the tube 15 and the inner surface of the convergent section 8. The turbine 14 is preferably mounted by fixing to a support plate 17 via a bolted flange 18. Such an arrangement provides easy removal for maintenance. It should, however, be appreciated that numerous alternative mounting arrangements will be possible. The turbine 14 preferably comprises of guide vanes 19 and blades mounted on a hub 21. As water flows through the turbine the blade assembly drives the rotation of a turbine drive shaft 22. It should again be appreciated, however, that the turbine 14 need not be limited to any specific construction. Numerous alternative turbine constructions will be readily appreciated by those skilled in the art.

A first flow path for the primary flow is defined within the annulus between the turbine draft tube 15 and the convergent section 8. A second flow path for a secondary flow is defined through the turbine 14 and draft tube 15. It should be appreciated that the annulus is not restricted to a circular, ring shaped space between the tube 15 and the inner walls of the convergent section 8. The shape of the annulus will depend on the cross-sectional shape of the convergent section 8 and the turbine draft tube 15, which may take numerous differing profiles.

The convergent section 8 accelerates the primary flow creating a low-pressure zone at the venturi 13. The low-pressure zone induces the secondary flow through the turbine 14. Both the primary and secondary flows enter the mixing duct 9 where the two flows mix. The mixed flow enters the diffuser section 10, wherein the velocity of the water flow slows as it moves through the diffuser section 10. As the water flows through the diffuser section 10 the flow regains its static head and loses its dynamic head before it exits the diffuser section 10. There is preferably provided a tailpipe section 11, as shown, downstream of the diffuser section 10. When provided, this acts to preserve the low static head in the venturi.

The primary flow will pass through the annulus formed between the convergent section 8 and the turbine draft tube 15. A smaller volume of water, the secondary flow, will flow through the turbine 14 driving the rotation of the turbine hub 21 and the drive shaft 22, as it flows past the blades 20. As the primary flow converges towards the venturi 13, the primary flow accelerates reducing the static head. The high-speed primary flow outside the tube 15 at the exit of the tube assists in drawing the slower secondary flow out of the end of the tube 15 into the mixing chamber 9.

Accordingly, a high volume, low head flow is turned into a low volume high-head flow from which electrical power can be generated efficiently via the rotating turbine drive shaft 22.

The inlet tube 5 is configured such that the upstream end is fully submerged under the upstream body of water.

A non-limiting, exemplary, inlet is shown in FIG. 1. To control the flow through the apparatus a flow control means 34, which may, for example, take the form of a sluice gate or valve is fitted, which can, for example, be located in the inlet tube 5, in the mixing duct 9, or in the tailpipe 11. In the present arrangement, the control means comprises a sluice gate, which may be open, closed or any position in between. The sluice gate is preferably operated by an actuator 35. The control of the actuator is preferably via a control system which is programmed to operate the gate as a function of the downstream and upstream water levels.

FIG. 2 shows an exemplary modified inlet arrangement, which takes the form of a siphonic inlet. A siphon inlet pipe 36, with its upstream end submerged below the upstream water level 2 and downstream end connected to the inlet pipe 5. The downstream connection may be through a bolted flange, as shown, or otherwise, as will be appreciated by those skilled in the art. The siphon pipe inverts to rise above the upstream water level. To commence flow through the apparatus air may be pumped out from the siphon pipe using a vacuum pump, which may be controlled by the control system. As will be readily appreciated, removing the air in the siphon pipe reduces the pressure and draws water up through the pipe. Once the pressure is sufficiently low siphonic action will commence drawing water through the pipe. At this point the air pump can be turned off. In order to stop the flow, there may, for example, be a valve provided, which can be opened drawing air into the pipe and reducing the pressure to a point where flow ceases.

A siphonic installation is useful since it can reduce the requirement for large scale excavations, thus reducing costs and installation time.

A debris screen 4 is preferably fitted upstream of the inlet to prevent large debris entering the apparatus.

The turbine 14 may be mounted on a support skid 16, as shown. It may otherwise be welded or mechanically fastened within the turbine chamber 7. The turbine, whether mounted via a skid or otherwise, may be supported by any suitable support means, such as a plate or a frame. In the depicted arrangement, there is provided a plate 17, which is attached to the skid and comprises a bore for receiving and supporting the turbine tube 15 such that longitudinal axis of the turbine tube 15 is substantially aligned with the longitudinal axis of the convergent section 8. In an alternative arrangement, the turbine 14 may be mounted on radial supports and fastened to the internal walls of the turbine chamber 7. Irrespective of the mounting arrangement, the turbine is preferably arranged such that the longitudinal axis of the turbine tube 15 is substantially aligned with a longitudinal axis of the convergent section 8.

The turbine draft tube 15 provides a flow path between the high static head in the turbine chamber 7 and the low static head in the venturi 13. The secondary flow passes through the turbine 14 and turbine draft tube 15, induced by the amplified head drop between the upstream end of the turbine tube 15 and the venturi.

The turbine draft tube 15 may have a substantially constant internal diameter along its length. It may alternatively taper towards its downstream end, as shown, for example, in FIG. 11. As shown, the diameter of the turbine tube converges along its length such that the entrance of the turbine draft tube has a larger diameter than the exit of the turbine draft tube. Providing a tapered turbine tube may aid in generating higher efficiencies for the apparatus, increasing the performance of the venturi.

The turbine tube 15 can be of a length sufficient such that it is positioned just in front or inside the mixing duct to span the high pressure in the turbine chamber 7 to the low pressure at the venturi 13. As shown, for example in FIG. 10, the downstream end of the turbine draft tube 15 can be located within the mixing chamber (or tube) 9, extending into the mixing tube by a distance X. The distance X may be selected to optimise the performance of the device and can be zero, positive or negative. When the distance X is positive the turbine tube extends into the mixing tube. When the distance X is negative the exit of the turbine tube terminates upstream of the entrance of the mixing tube. When the distance X is zero the exit of the turbine tube is substantially in line with the entrance of the mixing tube.

A power off take arrangement for the apparatus may take any of various different forms, as will be readily appreciated by those skilled in the art. Two, non-limiting, exemplary, power take off options for the apparatus are discussed below. The power take off arrangement may be mechanical or electrical, wherein an example of each is discussed below in detail.

An exemplary mechanical off take arrangement is shown in FIG. 11. The rotation of the turbine shaft 22 drives a chain or belt 23 connected to the shaft of a generator 25. The generator is mounted outside of the turbine chamber 7. Whilst numerous structures will be readily appreciated for effecting such an arrangement, a specific, non-limiting, arrangement is discussed in detail below for illustrative purposes only.

The chain or belt 23 extends up through the turbine chamber 7. A sealing cover 26 is preferably positioned over the chain/belt to prevent the ingress of water. The sealing cover 26 may, for example, take the form of a pipe or tube. The sealing cover is preferably sealed at the base and at the tube duct. Any suitable sealing arrangement may be implemented. O-rings or flanged connections may be used, for example.

The turbine drive shaft 22 passes through a sleeve 27 which houses all bearings 28, 29, seals 30, and power offtake spigots/pulleys 24. The drive shaft assembly is preferably sealed to minimise the frictional drag on the drive chain and to help reduce the risk of corrosion. The downstream face of the drive shaft sleeve may be connected to the turbine hub via a sealed flange. Upstream, the drive shaft sleeve may be blanked off. There may be provide fixing means for the screen, such as blind tapped holes. There may be provided a profiled nose for reducing hydraulic losses.

The drive shaft is preferably supported by a pair of bearings. The bearings may, for example, be water lubricated bushes or roller bearings. The downstream bearing 28 may be a roller bearing or a water lubricated polymer bush supported radially in the drive shaft sleeve 27, or otherwise. The bearing, bush or otherwise may be secured by conventional means, for example, such as via mechanical fastenings or via an interference fit. The upstream bearing may, for example, comprise a thrust bearing 29, which is preferably configured to prevent the turbine tube from moving axially downstream as the turbine rotates. The thrust bearing may be supported radially and longitudinally by any conventional means. It may be supported radially within the drive shaft sleeve 27 and longitudinally by an internal flange, or otherwise. Thrust forces from the turbine may be transferred through the drive shaft sleeve and into the turbine support skid 16, or other mounting means.

The chain spigots or belt pulleys 24 are preferably located on the drive shaft 22 and may be fixed by any conventional means, for example via mechanical fastenings or via interference fits. The chain or belt 23 is connected and extends to a point outside the turbine chamber 7. As will be readily understood by those skilled in the art, the chain/belt can extend at any point around the circumference of the turbine duct, as appropriate for the installation.

The sealing cover 26, which is preferably positioned over the chain/belt 23, can be profiled or fitted with an additional fairing to reduce hydraulic losses in the flow, such that disturbances of the flows in the duct are minimised.

A generator 25 is located outside of the turbine chamber 7. Its location is not limited. It is preferable, however, that it is mounted out of the water, i.e. in the dry. The generator may, for example, be supported by an external turbine chamber support structure 12. Such a structure could, as shown, comprise a skid but need not be limited as such. It is preferable that the generator shaft is fitted with a spigot/pulley for connection to the chain/belt 23. The ratio of the spigot/pulley can be modified to provide a speed step up in speed from the turbine to the generator. There could additionally or alternatively be a gearbox provided between the turbine and generator.

The generator may be controlled by a variable speed controller which controls the speed of the turbine by varying the electrical load on the generator in order to maximise power output from the system.

It is preferable that water is removed from within the drive shaft sleeve 27 so as to help minimise the frictional drag on the drive chain 23 and also help to reduce the risk of corrosion.

The drive shaft sleeve may be connected with the venturi 23 via an air hose 33, which may, for example, be formed from nylon. Water may thereby be passively pumped out during operation by the low pressure in the venturi. In the absence of water in the drive shaft sleeve air will be pulled through the hose to the point where the pressure in the drive shaft sleeve equalizes with the venturi, and no fluid will pass.

An electrical power off take arrangement is now considered. In such an arrangement, power and signal cables will run from the turbine within the turbine chamber to a generator located outside the turbine chamber 7. Again, whilst numerous structures will be readily appreciated for effecting such an arrangement, a specific, non-limiting, arrangement is discussed in detail below for illustrative purposes only.

A permanent magnet, a synchronous generator or an asychronous generator, or otherwise, may be coupled directly to the turbine runner and supported structurally via a flange, or otherwise, on the turbine guide vanes. The generator is preferably sealed. It may, for example, be sealed with static O-rings and mechanical seals to prevent the ingress of water. All bearings are located within the generator housing. Power and signal cables may run via glands, or similar, from the generator and may run through a sealed conduit outside the turbine chamber.

The generator can be connected to the venturi via an air hose so as to passively pump any water ingress, via the low pressure in the venturi, which may have breached the seals. In the absence of water in the generator air will be pulled through the hose to the point where the pressures will equalize, and no fluid will pass. To prevent water ingress back through the air hose one or more non-return valves can be fitted. The air hose can also be taken out with the signal cable and looped back down through the conduit such that the high point of the hose is above the maximum water level.

Returning to the turbine chamber 7, as provided in accordance with any embodiment, this is preferably in the form of a circular duct having an entrance for receiving flow from upstream of a the barrier at one end and an exit to release flow into the converger 8. Whilst numerous mounting options exist, for mounting the turbine chamber in situ, it is preferable that the turbine chamber 7 is mounted on a structural skid 12, as shown. The skid may, for example, be mounted onto a concrete pad in order to reduce installation time, costs and complexity on site.

During operation, the turbine chamber 7 is pressurised by the upstream water level 2 and remains full of water during operation. By running the turbine duct as a pressurised chamber without a free surface, free surfaces vortices cannot be created, which is highly beneficial.

The turbine duct 7 is preferably provided with a maintenance hatch 39, which is sealed to maintain working pressure during operation. The maintenance hatch is preferably profiled in conformity with the hatch. In the depicted arrangements, it is profiled to maintain the internal circular form of the turbine duct so as to reduce hydraulic losses.

A turbine assembly, which comprises, for example, the turbine 14, turbine draft tube 15, generator and screen 38 (where present—as discussed below), may be mounted together to form a single assembly. The turbine assembly may further comprise the power offtake components 27, 24, 22. The turbine assembly may be mounted, for example, on a fixed skid 12 to form the single assembly. Such an arrangement is beneficial for reducing installation time and costs and helping site positioning of the apparatus. Assembly and functional testing of the turbine assembly may be conducted away from site. During assembly on site, the turbine assembly may be lifted though the maintenance hatch 39 and positioned within the turbine chamber 7. The turbine assembly, comprising the skid or otherwise may be fitted with profiled plates to confirm with the profile of the turbine chamber, such as maintaining an internal circular form of the turbine chamber, in order to reduce hydraulic losses.

Maintenance of the turbine and other mechanical equipment can be made by removing the entire turbine assembly from within the turbine duct 7 and transporting it to a workshop. This also provides the benefit of minimising downtime, wherein a spare turbine assembly may be swapped in upon removal of the turbine assembly for maintenance.

In siphon arrangements, where the invert of the mixing duct 9 is positioned above the downstream water level 3. By preventing flow from entering upstream (via a sluice, breaking the siphon, stop logs or gate valve, or otherwise), the apparatus will self-drain. After pumping any remaining standing water, safe, dry access can be made via the maintenance hatch 39.

Where required, a fish screen 38 may be bolted to the front of the turbine 14 to prevent fish and aquatic life entering the turbine. The screen 38 may be conical in form. The screen 38 may comprise bars that run longitudinally, parallel to the flow. Such an arrangement is beneficial for reducing hydraulic losses. The spacing of the bars may increase towards the turbine. The maximum spacing of the bars may be selected based on the species of fish and other aquatic life present in the watercourse.

Considering a conical screen 38, the secondary flow, Qs, passes through the screen, the remaining flow, Qp passes over and around the screen. As the remaining flow passes over the screen it will passively clean the screen ensuring it remains free of debris during operation. The angle of the screen can be selected such that the flow velocities perpendicular to the screen are low enough to prevent fish and other aquatic life from being impinged. A nose cone may be provided at the front of the screen for further reducing hydraulic losses and guiding fish safely away from the screen. Fish can pass safely though the venturi. The apparatus provides a safe, alternative route for fish to travel downstream,

The preferred integrated constructions of the components forming the turbine tube and support boss helps reduce installation time and costs and help site positioning of the apparatus.

The convergent section 8 is in the form of a funnel having a first opening as an entrance for receiving water from behind the barrier 1 at one end and a narrower opening as an exit at the opposite end to release water into the mixing chamber 9. The convergent section 8 tapers down from the upstream end towards the entrance of the mixing chamber 9. A venturi 13 is defined at the boundary of the convergent section and mixing tube. The parameters of the convergent section, such as the angle of convergence, the length the section, and the size, such as the diameters of the entrance and exit of the convergent section, can be selected to optimise the performance of the apparatus, as will be appreciated by those skilled in the art.

The mixing chamber, which may take the form of a mixing pipe/tube as shown, provides a section in the apparatus in which the secondary flow Qs and primary flow Qp can combine to form a substantially uniform flow. The flow is substantially homogenous before exiting the mixing chamber 9 into the diffuser section 10 with a velocity profile that allows sufficient pressure recovery in the flow through the diffuser section to sustain the pressure difference between the low pressure at the venturi and the higher pressure at the exit of the diffuser section.

The mixing tube is configured to maximise the power output of the turbine tube through which the secondary flow [Qs] passes. This is achieved, at least in part, by the mixing section being configured to optimise the flow regimes in the region immediately downstream of the point where the secondary flow through the turbine induced by the low pressure in the venturi starts to co-mingle with the primary flow. The mixing tube is configured to optimise the energy transfer from the primary flow into the secondary flow in this mixing tube.

The mixing chamber has an opening, an exit and non-zero length to provide a space of sufficient length in between the opening and the exit in which the flows can mix. The length L of the tubing defining the mixing tube is selected such that an appropriately conditioned flow is obtained before the flow enters the diffuser section. Selecting the correct length for the flow and pressure conditions ensures that there is optimum energy transfer between the fast moving primary flow and the slower secondary flow, such that there is an acceptable velocity profile across the two flows before the combined flows enters the diffuser section. It has, uniquely been determined by the present inventors, through diligent research, that it is particularly beneficial when the mixing chamber has a length that is at least double its diameter.

In one embodiment of the invention the mixing chamber can taper in the downstream direction by a half cone angle of R>, beta, such that the exit of the mixing chamber is narrower than its entrance. The half cone angle of the mixing chamber can be positive or negative. In an alternative embodiment the mixing chamber can taper in the upstream direction such that the exit of the mixing chamber is wider than the entrance of the mixing chamber, i.e. the mixing chamber diverges along its length towards the diffuser section.

Having a tapered mixing chamber can facilitate the energy transfer between the higher speed primary flow through the annulus and the slower secondary flow exiting the turbine tube.

The downstream end of the mixing chamber 9 is connected to the diffuser section 10. The diffuser section is in the form of a funnel having a first opening as an entrance for receiving water from the mixing tube 9 and a wider opening as an exit at the opposite end to release water. As discussed, water is preferably released into the tailpipe 11 before discharging back into the free flow on the downstream side of the barrier 1. The diffuser section 10 diverges outwardly from the exit of the mixing tube 9 to slow the flow down and recover static pressure before it exits the diffuser section 10 and to minimise energy loss through turbulence. The angle of diversion can be selected to optimise the performance of the diffuser.

The parameters of the diffuser section, such as the length of the section, angle of divergence, and the ratio of the cross sectional area of the first and second openings are selected to suppress turbulence and to reduce energy losses caused by flow breakaway, as the flow decelerates back down to the free stream velocity. Undue turbulence, eddies and flow breakaway can impair pressure recovery as the flow approaches the exit of the diffuser section. The parameters are selected to maximise pressure recovery such that the pressure at the diffuser exit, which is set by the downstream water depth, is as high as possible above the pressure at the venturi, as will be readily appreciated by those skilled in the art.

The convergent section 8, mixing tube 9, diffuser section 10 and tailpipe 11 can be manufactured as a single continuous tube. Alternatively, the convergent section, mixing tube diffuser and tailpipe can be manufactured in one or more separate sections fastened together by bolts or by other conventional joining means or techniques. As shown in FIG. 8 and FIG. 9 the convergent section, mixing tube, diffuser and tailpipe can be manufactured as individual components, with the two adjoining sections held together by a bolted flange 40.

Radiused transitions can be formed between any two adjacent sections to minimise energy losses due to induced turbulence that may occur if sharp edge transitions between the sections are present. This will help enhance the energy conversion efficiency of the system.

A typical hydropower dam, where a barrier across a source of water channels all the flow of water through of turbine requires a head difference of typically 3.5 m or more to make the generator work efficiently. However, because of the pressure amplification in the induced secondary flow the invention can operate such a turbine cost-effectively at head differences from around 1.0 m.

Therefore, the disclosed arrangements are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Although various example embodiments have been disclosed, a worker of ordinary skill in this art would recognize that certain modifications would come within the scope of this disclosure. For that reason, the following claims should be studied to determine the scope and content of this disclosure.

1. An apparatus for generating electricity from water flow comprising:
a convergent section connected at a downstream end thereof to an upstream end of a mixing chamber such that a venturi is formed;
a diffuser section connected to a downstream end of the mixing chamber, the diffuser configured such that in use the static pressure at the exit of the diffuser is greater than the static pressure at the venturi;
at least part of a tube located in the convergent section, such that an annulus is defined between the tube and the convergent section, to form a first flow passage, and the tube defining a second flow passage within the tube; and
a turbine, which is connected with the tube and connectable to a generator,
wherein the turbine is located within a turbine chamber that is connected at a downstream end thereof to an upstream end of the convergent section.

2. An apparatus as claimed in claim 1, wherein the turbine chamber is connected at an upstream end thereof to an inlet pipe.

3. An apparatus as claimed in claim 1, wherein the turbine chamber is connected to the inlet pipe via a second diffuser.

4. An apparatus as claimed in claim 2, wherein the inlet pipe comprises a siphon.

5. An apparatus as claimed in claim 1, wherein the turbine chamber is pressurised in use.

6. An apparatus as claimed in claim 1, wherein the turbine chamber has a substantially constant cross-sectional area.

7. An apparatus as claimed in claim 1, wherein the turbine chamber comprises a substantially cylindrical inner surface.

8. An apparatus as claimed in claim 1, wherein the turbine chamber comprises a hatch in a wall thereof for providing access to the inside of the turbine chamber.

9. An apparatus as claimed in claim 1, wherein the turbine and tube are mounted to a turbine support structure, which is detachably mounted within the turbine chamber.

10. An apparatus as claimed in claim 9, wherein the turbine support structure comprises a skid.

11. An apparatus as claimed in claim 1, wherein the turbine and/or the tube is slidably mounted within the turbine chamber.

12. An apparatus as claimed in claim 1 further comprising a tailpipe, which is connected to an outlet of the diffuser.

13. An apparatus as claimed in claim 1, wherein the turbine chamber comprises a self-contained unit that is separable from the remainder of the apparatus.

14. An apparatus as claimed in claim 1, wherein the mixing chamber has a length that is at least double its diameter.

15. An apparatus for generating electricity from water flow comprising:
a convergent section connected to an upstream end of a mixing chamber such that a venturi is formed;
a diffuser section connected to a downstream end of the mixing chamber, the diffuser configured such that in use the static pressure at the exit of the diffuser is greater than the static pressure at the venturi;
at least part of a tube located in the convergent section, such that an annulus is defined between the tube and the convergent section, to form a first flow passage, and the tube defining a second flow passage within the tube; and
a turbine, which is connected with the tube and connectable to a generator,
wherein the mixing chamber has a length that is at least double its diameter.

16. An apparatus as claimed in claim 15, wherein the mixing section is substantially cylindrical.

17. An apparatus as claimed in claim 15, wherein the mixing section is tapered at an angle of up to 4 degrees.

18. A system for generating electricity from water flow comprising; a barrier for locating across the cross-section of a flowing body of water, and at least one apparatus as claimed in any preceding claim, wherein the at least one apparatus is arranged to provide a flow path from the upstream side of the barrier to the downstream side of the barrier.

19. A method of generating electricity from a flow of water comprising: installing a system as claimed in claim 18 across a body of water to provide a reservoir of water, such that a head difference is created between the downstream and upstream sides of the barrier; and using the flow of water through the apparatus to rotate the turbine.

20. A method for providing a flow passage through a barrier across a body of water comprising: installing an apparatus as claimed in claim 1 in the barrier.
